(19) United States
(12) Patent Application Publication
(10) Pub. No.: US 2024/0369201 A1
(43) Pub. Date: Nov. 7, 2024

(54) VEHICLE LIGHTING DEVICE

(71) Applicants: HELLA Saturnus Slovenija D.O.O., Ljubljana (SI); HELLA GmbH & Co. KGaA, Lippstadt (DE)

(72) Inventors: Giuseppe MATTINA, Lippstadt (DE); Willi GLATTER, Ljubljana (SI); Ansgar GOLLNICK, Paderborn (DE)

(73) Assignees: HELLA Saturnus Slovenija D.O.O., Ljubljana (SI); HELLA GmbH & Co. KGaA, Lippstadt (DE)

(21) Appl. No.: 18/775,983

(22) Filed: Jul. 17, 2024

Related U.S. Application Data
(63) Continuation of application No. PCT/EP2022/050985, filed on Jan. 18, 2022.

(51) Int. Cl. F21S 41/24

(52) U.S. Cl. CPC F21S 41/24; F21S 41/2805

(57) ABSTRACT

A vehicle lighting device comprising a housing and a plastic cover pane covering the front opening of the housing. The vehicle lighting device comprises an illuminant configured to emit light into the cover pane via a rim-sided light-incoupling section. The cover pane is configured at least in sections as a light-guide element featuring a light-outcoupling section with outcoupling elements such that light of the illuminant is emittable from the light-outcoupling section.

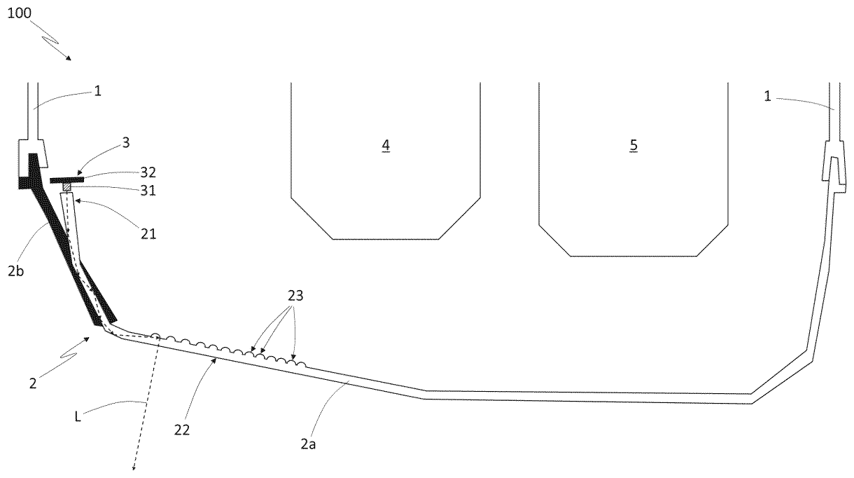

This nonprovisional application is a continuation of International Application No. PCT/EP2022/050985, which was filed on Jan. 18, 2022, and which is herein incorporated by reference.

### BACKGROUND OF THE INVENTION

### Field of the Invention

The present invention relates to a vehicle lighting device comprising a housing and a plastic cover pane covering the front opening of the housing.

### Description of the Background Art

In modern motor vehicle lighting devices, light-guide components are frequently used, with the particular aim of creating a homogeneous light impression over a wide area. For this purpose, the light-guide components typically comprise a large number of expediently arranged outcoupling elements in the form of geometric scattering centers introduced into the surface, for example by means of surface structuring, etching or the like. Light is usually coupled-in via a section at the rim of the light-guide components, and light guiding is typically based on the principle of total reflection. Such light-guide components serve, for example, as daytime running lights, as direction indicators or also as design elements, pictograms, logos and the like.

For example, the document DE 10 2020 102 602 A1, which is incorporated herein by reference, discloses a lighting unit for a vehicle lighting device, comprising an elongated light-guide component in a holding device arranged behind the transparent cover pane of the lighting unit, the light-guide component being designed to couple-out light over its longitudinal extension and to form a required light signature along a bending line.

Furthermore, the document AT 520399 A1 discloses a vehicle lighting device, comprising an elongated light-guide component, an aperture and a plate-like light-guide component arranged one after the other behind the cover pane of the lighting device.

### SUMMARY OF THE INVENTION

It is therefore an object of the present invention to provide a vehicle lighting device featuring an improved light-guide.

In an example, a vehicle lighting device is provided comprising a housing and a plastic cover pane covering the front opening of the housing, and discloses that the vehicle lighting device comprises an illuminant configured to emit light into the cover pane via a rim-sided light-incoupling section, wherein the cover pane is configured at least in sections as a light-guide element featuring a light-outcoupling section with outcoupling elements, such that light of the illuminant is emittable from the light-outcoupling section.

An idea of the invention lies in the use of the plastic cover pane itself as the light-guide component of the vehicle lighting device. This eliminates the need for separate light-guide components as known from the prior art. The construction of the vehicle lighting device can thus be made more compact and there is greater freedom with regard to the technical configuration and design aspects. Moreover, the assembly process of the vehicle lighting device can be carried out more quickly due to the smaller number of components to be assembled with each other, which is a major economic advantage for mass-produced devices.

As with conventional vehicle lighting devices, the cover pane serves to protect the interior of the housing, in which the lighting modules are housed, from the ingress of water, dust, dirt and the like. In addition, according to the invention, it functions at least in sections as a light-guide element, i.e., as a light-guiding and light-emitting component, for which purpose suitable light-incoupling and light-outcoupling sections must be provided.

The light-incoupling section can be formed by a rim-sided section of the light-guide element an the related illuminant is arranged to radiate light into the cross-section of the light-guide element. In particular, the light-incoupling section extends over the lateral, upper and/or lower rim of the light-guide element with respect to the intended mounting pose of the vehicle lighting device. The vehicle lighting device can for instance be configured as a head light and its intended mounting pose in the front end of a motor vehicle defines the spatial designations. The light-incoupling section may comprise a plurality of sub-sections spaced apart from each other and each be provided with one or more belonging illuminants. Likewise, the light-outcoupling section may comprise a plurality of sub-sections distributed over the light-guide element spaced apart from each other. The light guiding inside the light-guide element is Preferably based on total reflection of light at the interface between the light-guide element and the surrounding.

The cover pane can comprise a transparent component forming the light-guide element and an opaque component forming a cover element, wherein the cover element covers the light-incoupling section such that the light-incoupling section is not visible from the outside in an intended mounting position of the vehicle lighting device. The transparent component may for instance be formed of polycarbonat (PC) or poly(methyl methacrylate) (PMMA), which offer suitable light-guiding properties.

The outcoupling elements in the light-outcoupling section can be arranged on the inner side of the light-guide element, i.e., on the side facing the interior of the housing. The outcoupling elements form geometric scattering centers to scatter light towards and out of the outer side of the light-guide element. The outcoupling elements may be formed as dimples, pyramids or other free-form bodies, or as dedicated surface roughness. The outcoupling elements may be introduced either already during forming of the light-guide element or afterwards by an appropriate surface treatment, e.g., laser structuring, mechanical structuring, eroding, etching, printing or the like. Alternatively, the outcoupling elements can be arranged on a carrier foil and applied together with this foil to the light-guide element. Furthermore, the outcoupling elements may be arranged on the outer side of the light-guide element or on both sides, although the arrangement on the inner side advantageously offers the best wear protection.

Preferably, the cover pane can be formed as an injection molded part, especially as a multi-component injection molded part. For instance, the example featuring a transparent component forming the light-guide element and an opaque component forming the cover element may be produced by two-component injection molding. Further components, e.g., components of different color and/or of different degrees of translucency may be integrated as well, especially for design purposes.

Additional details, characteristics and advantages of the object of the invention are disclosed in the following description of the FIGURE—which in an exemplary fashion—shows a preferred embodiment of the invention. It is obvious to the person skilled in the art that the proportions in the FIGURE are not shown true to the original, but that they are purely schematic representations for the purpose of illustration.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWING

The present invention will become more fully understood from the detailed description given hereinbelow and the accompanying drawing which are given by way of illustration only, and thus, are not limitive of the present invention, and wherein the sole FIGURE shows a cross-sectional partail top view of a vehicle device.

### DETAILED DESCRIPTION

The FIGURE shows a cross-sectional partial top view of a vehicle lighting device 100 according to the invention comprising the housing 1, the plastic cover pane 2 covering the front opening of the housing 1, and the two lighting modules 4, 5 accommodated in the interior of the housing 1.

The vehicle lighting device 100 furthermore comprises the illuminant 3 with the light-emitting diode 31 on the printed-circuit board 32 configured to emit light L into the cover pane 2 via the rim-sided light-incoupling section 21, wherein the cover pane 2 is configured in sections as the transparent light-guide element 2a featuring the light-outcoupling section 22 with outcoupling elements 23, such that the light L of the illuminant 3 is emittable from the light-outcoupling section 22. The irradiation of the light L into the cross-section of the light-guide element 2a takes place via the narrow end face at the rim-sided light-incoupling section 21. With respect to the intended mounting pose of the vehicle lighting device 100, the light-incoupling section 21 extends over the left lateral rim of the light-guide element 2a.

The propagation of the light L inside the light-guide element 2a towards the light-outcoupling section 22 is based on total reflection at the interface. The light-outcoupling section 22 features the outcoupling elements 23 on the inner side of the light-guide element 2a. The outcoupling elements 23 are exemplarily formed as half-spheres and are distributed in a dedicated pattern for homogeneous light emission.

In addition to the transparent component forming the light-guide element 2a, the cover pane 2 comprises an opaque component forming the cover element 2b, wherein the cover element 2b covers the light-incoupling section 21 such that the light-incoupling section 21 is not visible from the outside in an intended mounting position of the vehicle lighting device 100.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A vehicle lighting device comprising:
a housing;
a plastic cover pane covering a front opening of the housing; and
an illuminant configured to emit light into the cover pane via a rim-sided light incoupling section, the cover pane being configured at least in sections as a light guide element having a light outcoupling section with outcoupling elements such that light of the illuminant is emittable from the light-outcoupling section.

2. The vehicle lighting device according to claim 1, wherein the light incoupling section extends over the lateral, upper and/or lower rim of the light-guide element with respect to the intended mounting pose of the vehicle lighting device.

3. The vehicle lighting device according to claim 1, wherein the cover pane comprises a transparent component forming the light-guide element and an opaque component forming a cover element, wherein the cover element covers the light-incoupling section such that the light incoupling section is not visible from outside in an intended mounting position of the vehicle lighting device.

4. The vehicle lighting device according to claim 1, wherein the outcoupling elements are arranged on an inner side of the light guide element.
